(19) United States
(12) Patent Application Publication
(10) Pub. No.: US 2006/0134300 A1
(43) Pub. Date: Jun. 22, 2006

(54) Nutritional supplement for caffeine-containing beverages

(76) Inventor: Arnold L. Newman, Bethesda, MD (US)

Correspondence Address: Arnold L. Newman, 8220 Hamilton Spring Court, Bethesda, MD, 20817-2714, US

(21) Appl. No.: 11/017,019

(22) Filed: Dec. 20, 2004

(51) Int. Cl. A23L 2/00

(52) U.S. Cl. 426/590

(57) ABSTRACT

An alertness inducing composition contains the active ingredients caffeine and taurine and various inert substances in a dry formulation. Caffeine and taurine are delivered in an oral formulation that obviates the need for ingesting significant quantities of liquid or sugar.

### BACKGROUND OF THE INVENTION-FIELD OF THE INVENTION

This invention relates to a nutritional supplement composition that is added to caffeine-containing beverages so as to render such beverages more palatable, nutritious, or effective in inducing alertness. More specifically, it relates to a mixture of ingredients, including taurine, that improves the taste and function of caffeine-containing drinks such as coffee, tea, cocoa, sodas, and the like. Generally, it provides a convenient, measured, and easy way to improve the nutrition and functionality of caffeine-containing beverages.

### BACKGROUND OF THE INVENTION-RELATED ART

Caffeine has been used as a stimulant, alertness, and anti-sleep aid for centuries. While the most common source of caffeine is coffee, it is also found in other natural plant sources such as tea, cocoa, cola nuts, yerba maté and others. Chemically, caffeine is 1,3,7-trimethylxanthine, and related to theophylline (1,3-dimethylxanthine) and theobromine (3,7-dimethylxanthine). It is a bitter, white, water-soluble alkaloid powder.

Drinking coffee has long been recognized as a way to increase wakefulness and alertness. For example, many people drink coffee for its caffeine content to become fully awake and alert in the morning. In many work places, coffee is provided throughout the day so that people can operate at peak alertness and efficiency. Students appreciate the benefits of coffee in helping them study long into the night. An 8 ounce cup of coffee typically contains between about 80 mg and 150 mg or more of caffeine. An equal volume of tea delivers between about 30 mg and 70 mg of caffeine.

Caffeine acts as a diuretic and has a stimulatory effect on the central nervous system, the heart, and the respiratory system. Thus, in addition to being a stimulant of the central nervous system, it also has peripheral effects, which, at high doses, can be a problem for some individuals. For example, even moderate amounts of caffeine can cause a rapid heartbeat or palpitations (ectopic heartbeats) in some sensitive people. Other side effects of excessive caffeine can include anxiety, insomnia, diarrhea, diuresis, facial flushing, restlessness, irritability, and trembling. There is a need for a way to achieve the benefits of caffeine while diminishing the possibility of suffering physiologic discomfort.

In the last several years, so-called “energy drinks” have become available in the U.S. market. These drinks are in the category of “functional beverages,” which also includes sports drinks and other nutritionally fortified beverages. Functional beverages are intended to do more than quench thirst. Some functional beverages are used to restore electrolytes before, during, and after athletic events. Others provide substances of nutritional or nutraceutical benefit. Functional energy drinks are usually a source of stimulants that produce alertness, wakefulness, and a high-energy state as perceived by the drinker.

Energy drinks are usually soft drinks, often available in 250 ml or larger quantities, and are a mixture of ingredients that usually includes at least one stimulant and additional nutrient components such as amino acids, vitamins, and sweeteners. Caffeine is the most common stimulant in these drinks, but other ingredients, such as taurine, glucuronolactone, guarana, ginseng extract, herbal extracts, and vitamins, can also be found in various energy drinks.

A popular energy drink is Red Bull®, which lists as its ingredients: carbonated water, sucrose, glucose, sodium citrate, taurine, glucuronolactone, caffeine, inositol, niacin, D-pantothenol, pyridoxine HCL, vitamin B12, artificial flavors, colors. Red Bull® Sugar Free drink lists as its ingredients: carbonated water, sodium citrate, taurine, glucuronolactone, caffeine, acesulfame k, aspartame, inositol, xanthan gum, niacinamide, calcium pantothenate, pyridoxine HCl, vitamin B12, artificial flavors, colors. Both versions of Red Bull® contain approximately 1000 mg of taurine and approximately 80 mg of caffeine (within the range typically found in a cup of coffee).

Much of the market success of functional energy drinks is due to the aura that has been associated with their use by young people in clubs and bars. Despite having a taste that some perceive to be unpleasant and/or artificial, these drinks have acquired a reputation for providing a “legal high” or mild euphoria, and, as a result, have become extremely popular. While the putative feeling of euphoria is likely a myth, enjoyment of these drinks is probably enhanced both by the fun environment in which they tend to be consumed, and the frequent concurrent use of these drinks with alcohol. Although these drinks are expensive, people are willing to buy them because by doing so, they buy into the aura and elan associated with these drinks. Currently, a single can of Red Bull retails for approximately two dollars. This is a lot of money to pay for a drink that delivers 80 mg of caffeine and 1000 mg of taurine.

There is a need for a less expensive product that can be added to a caffeine-containing beverage to yield an energy drink that is distinct from the psychosocial aura and elan associated with energy drinks currently available.

There appears to be a psychopharmacologic synergy among the ingredients of functional energy drinks. Taurine is a key ingredient in many such drinks. While caffeine is clearly a stimulant, its effects, in concert with taurine, are different from what one experiences from caffeine alone, such as by consuming a single cup of coffee (one can of Red Bull® provides 80 mg of caffeine, which is about equal to or less than is provided by most cups of coffee). Some studies suggest that taurine mitigates adverse effects such as those caffeine may produce.

Taurine (2-aminoethanesulfonic acid) is a conditionally essential amino acid because it is not incorporated into proteins, but it is found in a free form in many tissues, particularly muscle and nerve tissue. It is water soluble, and commercially available as a fine crystalline powder. Unlike most biological amino acids, taurine is a sulfonic acid rather than a carboxylic acid. Also, it is a beta-amino acid, not an alpha-amino acid, and it lacks a chiral center. It is a neuroinhibitory transmitter and may help regulate heart and skeletal muscle contractions, osmotic balance, energy levels, and brain neurotransmitter levels. In rats, the LD 50 of taurine is greater than 5,000 mg/kg.

Taurine appears to have several potentially useful psychological/neurological effects. It has been described as a possible anxiolytic (Chen, S W. et al., Life Sciences 2004 Aug. 6;75(12):1503-11) and an anti-epileptic (El Idrissi A, et al., Adv Exp Med Biol. 2003;526:515-25). It may alleviate visual fatigue (Zhang M, et al. Amino Acids 2004 February;26(1):59-63), attenuate amnesia (Vohra B P and Hui X, Neural Plast. 2000;7(4):245-59), and reduce peripheral sympathetic activity (Chahine R. et al., Arzneimittelforschung. 1994 February;44(2):126-8; Mizushima S, et al., Adv Exp Med Biol. 1996;403:615-22). As a reducer of peripheral sympathetic activity, taurine may counteract the unpleasant side effects of caffeine without inhibiting the beneficial stimulating effects of caffeine. Thus, for example, in the “Opinion of the Scientific Committee on Food on Additional information on “energy” drinks” (5 Mar. 2003), the view was expressed that “taurine might reduce the cardiovascular effects of caffeine.” (European Commission Health & Consumer Protection Directorate, Brussels Belgium, p. 8, available on the internet at: europa.eu.int/comm./food/fs/sc/scf/out169_en.pdf).

People often add substances to caffeine-containing drinks such as coffee, tea, and the like. For example, cream or milk of various fat contents is frequently added to coffee and tea. Small containers of cream, “half and half,” and milk are provided in restaurants and coffee shops in portions appropriate to a beverage serving. For many coffee and tea drinkers, dairy additives impart a pleasant taste, lessen the bitterness of some brews, and cool the beverage somewhat. Some drinkers add sugar or an artificial sweetener to their caffeine-containing beverage to improve taste. Adding cream, milk, and sugar is not done to convert the beverage into a functional energy drink, however. Furthermore, it is not known to add taurine and additional ingredients to caffeine-containing beverages to convert them to energy drinks.

Artificial substitutes for dairy products that are added to coffee or tea are known as creamers. Available as liquids and solid powders, these products, also known as whitening agents, are poured or spooned into a caffeine-containing drink for the same reasons mentioned above. U.S. Pat. No. 4,045,589 discloses a non-dairy fat emulsion product for use as a coffee whitener without protein but with a modified starch and pH buffer to stabilize the emulsion. U.S. Pat. No. 4,341,811 is a fluid non-dairy creamer made up of a lipoidal emulsion of edible fat, emulsifier, and water. U.S. Pat. No. 5,366,751 is a low fat, low calorie dairy creamer that contains skim milk, whey protein as a fat substitute, stabilizers, emulsifiers, carrageenan polysaccharides, and optional flavorings. U.S. Pat. No. 5,554,400 discloses an infusible beverage material such as coffee or tea and the like along with an additive co-agglomerated creamer base and sweetener base that are provided in an infusion bag. None of these patents discloses taurine as a creamer component, nor are any of them intended to change a caffeine-containing beverage into an energy drink.

U.S. Pat. No. 5,928,703 describes a soluble beverage powder made up of a soluble coffee powder and a soluble creamer-containing powder, which is reconstituted with water to for a coffee drink. U.S. Pat. No. 6,036,984 discloses another coffee drink as an instant coffee composition that is fortified with protein and other components to provide a “nutritionally complete and balanced” beverage. U.S. Pat. No. 6,207,203 also discloses a fortified coffee drink in powder form that is reconstituted with water, and which contains at least 25% of recommended daily intake per 8 oz. serving.

U.S. Pat. No. 6,235,317 describes an additive for stimulants particularly to reduce the health-damaging effects of coffee beverages.” It contains one or several vitamins, dandelion root extract, and, possibly, one or several mineral salts. It also contains anise extract and adenosine. U.S. Pat. Appl. No. 2002/0037830 discloses an additive for use “in any energy supplementation or metabolic nutrient in the form of a beverage or other nutrient” for those who need to increase their glycogen levels. The invention is primarily directed toward a protein hydrolysate as an additive to an energy supplementation or metabolic nutrient that can contain a carbohydrate component as well. No coffee or caffeine is mentioned in the specification. Neither of these two additive references discloses the use of taurine in a supplement that renders a caffeine-containing beverage into an energy drink.

In U.S. Pat. Application No. 2004/0096547, the inventor provides a “natural energy drink” that contains “one or more disaccharides, one or more carbohydrate complexes, one or more proteins, one or more stimulants and a vitamin premix which includes at least three vitamins.” Other ingredients are also listed for a preferred formulation, but taurine is not included. Furthermore, the invention is not intended as a supplement or additive that converts a caffeine-containing drink to an energy drink. In U.S. Pat. No. 5,817,364, the inventor describes an energy supply composition as “a beverage, or a dry composition therefore” in which the main ingredient is alpha-ketoglutaric acid or a salt thereof, in an aqueous medium. Neither taurine nor caffeine are mentioned.

Canadian Patent Appl. No. 2409834 describes an energy drink formula and method with ingredients that are primarily vitamins and minerals, and which include neither taurine nor caffeine. The drink is a powder that is reconstituted with water.

U.S. Pat. No. 6,261,589 discloses a soft drink that is a nutrient dietary supplement with a psychoactive effect. It is a carbonated beverage containing phenylalanine, vitamin B-6, vitamin C, copper, folic acid, taurine, vitamin B-5 (or pro-vitamin B-5), choline, fruit sugar, caffeine, and optionally, green tea. This combination of ingredients is disclosed as a means of increasing energy level and general awareness. The inventors claim that taurine helps prevent excessive sensitivity to noradrenaline and that it promotes “a mellow mood without sedation or tranquilization.” Thus, taurine may help one to avoid the discomfort associated with excessive sensitivity to, or intake of, caffeine. The disclosed soft drink also includes additional ingredients such as vitamins, sugar, and other nutrients. The invention of U.S. Pat. No. 6,261,589 is a complete drink that has its own caffeine. Unlike the present invention, it is not intended to be mixed with a beverage that already contains caffeine so as to change that caffeine-containing beverage into an energy drink.

PCT Application No. WO00/62812 discloses a nutritional composition for improved cognitive performance that comprises caffeine, choline, gamma aminobutyric acid, L-phenylalanine, and taurine in amounts sufficient to improve cognitive performance. In addition to the caffeine and taurine of this invention, several additional ingredients are used beyond what would be needed in a simple alertness aid.

Frontsiders LLC currently markets Umph®, which is an effervescent energy tablet that provides caffeine when it is added to a drink. According to its website (www.frontsiders.com), one tablet of Umph® contains caffeine (99 mg), ginseng (30 mg), Vitamin B6 (0.75 mg), Sodium (188 mg), Potassium (116 mg) as well as other ingredients that aid in effervescence. Taurine is not an ingredient of the formulation.

Xplode® is an effervescent tablet that, when mixed with water, produces an energy drink. Among other ingredients, it contains caffeine and taurine. Thus, as formulated, it provides the caffeine for the energy drink that results when it is added to water. This is in contrast to the present invention, which relies on the caffeine content of the caffeine-containing beverage with which it is mixed to yield an energy drink.

The combination of caffeine and taurine with other active ingredients in energy drinks and sweet products is known. However, no simple mixture of ingredients is available that, when mixed with a caffeine-containing beverage, works in combination with the caffeine already in that beverage. Thus, in the present invention, popular caffeine-containing drinks such as coffee, tea, cocoa, and colas, are converted into energy drinks without having to add additional caffeine per se.

There is a need for a product that converts a caffeine-containing beverage into a functional energy drink. Accordingly, it is desirable to provide a composition for improving alertness that relies on a combination of ingredients that, when added to a caffeine-containing beverage, yields a nutritionally supplemented beverage that is an energy drink.

### SUMMARY OF THE INVENTION

It is, therefore, an object of the present invention to provide a composition for improving alertness and generally stimulating a person's conscious state, relying on active ingredients that, when added to a caffeine-containing beverage, act together and with the caffeine of the caffeine-containing beverage to provide a safe, yet higher level of arousal in a human being, while minimizing potential discomfort due to untoward side effects of caffeine.

It is another object of the present invention to provide a composition for improving alertness comprising sufficient amounts of taurine and additional ingredients that, when mixed with a caffeine-containing drink, result in the drinker feeling more awake, alert, responsive and less fatigued, yet more comfortable than would result from using caffeine without taurine and the additional ingredients.

A further object of the present invention is to provide a composition of taurine and at least one additional ingredient that, when combined with a caffeinated beverage, work in concert with the caffeine physiologically to stimulate the user, but with a diminished likelihood of discomfort due to potential caffeine side effects.

An additional object of the present invention is to provide a composition for increasing a person's perception of mental and physical energy comprising a taurine-based supplement that is added to coffee, tea, cocoa, cola, or other caffeine-containing beverage to yield a functional energy drink.

According to the present invention, the above and other objects are accomplished with a composition and method for converting a caffeine-containing beverage into a functional energy drink by providing taurine and at least one additional ingredient in a measured amount for mixing with the caffeine-containing beverage.

For example, a coffee drinker could simply stir the contents of a container of a measured amount of selected ingredients into a cup of coffee, and thereby produce an energy drink. The container's contents can be either liquid or solid (e.g., granular). More specifically, for converting caffeinated coffee into an energy drink, the prospective drinker would add a container of nutritional supplement that contains taurine with a creamer, and/or a sweetener, and/or a flavoring. Additional ingredients such as glucuronolactone, other amino acids, vitamins, and other nutrients may also be provided as components of the supplement.

As another example, tea can be converted into an energy drink when mixed with a supplement that contains taurine and a sweetener. Additional ingredients such as glucuronolactone, other amino acids, vitamins, herbs, ginseng extract, green tea extract and/or other nutrients may also be provided in the supplement. Neither of these two examples is meant to be limiting in any way to the breadth and scope of the present invention.

### DRAWINGS NOT APPLICABLE

### DETAILED DESCRIPTION OF THE INVENTION

The present invention is a supplement that is added to a caffeine-containing beverage to convert it into an energy drink. It is provided in either a liquid or solid form (e.g., granular, powder, solid cake, or tablet, etc.) that is mixed with a caffeine-containing drink. Mixing may be facilitated by stirring or other agitation means.

There are a number of benefits and advantages to a nutritional supplement that, when added to caffeine-containing drink, converts it to an energy drink. People enjoy drinking coffee and tea. With the present invention, they can make their preferred caffeine-containing beverage into a functional energy drink without having to resort to the typical soft drink form of energy drink that is bottled or canned as a complete preparation. There is a cost advantage in using the nutritional supplement of the present invention. It allows consumers to enjoy the benefits of, for example, coffee and an energy drink together in one beverage, rather than having to purchase both coffee and an energy drink separately.

The present invention expands the market of people who will enjoy the benefits of an energy drink. Most energy drinks today are marketed to a youth and young adult market. However, coffee, tea, colas, and other caffeine-containing beverages constitute a much larger market, which would be receptive to a product that conveniently provides the ingredients to convert a caffeinated beverage into an energy drink. The present invention also provides a fortified supplement for use in caffeinated drinks, with additional nutrients not necessarily currently available in typical additives used with coffee, tea, and the like.

Caffeine has long been known in the art as a stimulant useful for increasing a person's level of alertness, wakefulness, or arousal. Because it is found in coffee, tea, cocoa, colas, and other foodstuffs, there is a long history of its use and a thorough understanding of its effects and actions. Unfortunately, caffeine is a broadly acting, non-specific stimulant because it stimulates both the central nervous system and the peripheral nervous system and, thus, has many physiological effects that can be uncomfortable to the user. For example, it can increase heart rate, diuresis, anxiety, and restlessness. According to Lane et al., “[c]affeine has significant hemodynamic and humoral effects in habitual coffee drinkers that persist for many hours during the activities of everyday life.” Furthermore, caffeine consumption could contribute to an increased risk of coronary heart disease in the adult population.” (Lane, J D, Psychosom Med. 2002 July-August;64(4):595-603) Caffeine is known to activate the sympathetic nervous system at least partly through the increased secretion of noradrenaline. Papadelis, et al., in a study of the effect of caffeine on adrenaline and noradrenaline (both are catecholamines) conclude that: “Both catecholamines were significantly increased with triple dose of caffeine.” (Brain Cogn. 2003 February;51(1):143-54)

Taurine is a non-essential amino acid that has been found to ameliorate and counteract some of the uncomfortable side effects of caffeine. When caffeine and taurine are taken together, some side effects of caffeine are diminished and the user feels less discomfort, while still benefiting from an increase in alertness. Thus, taurine can be used as a means for counteracting the negative side effects of caffeine. The present invention provides taurine and at least one additional ingredient for mixing with a caffeinated beverage.

Taurine mitigates and counteracts the possible side effects of caffeine ingestion. According to U.S. Pat. No. 6,261,589, caffeine can “cause neurons to release noradrenaline more readily and to be more sensitive to the effects of noradrenaline.” This patent describes taurine as a neuromodulator that can “modulate the activating effects of noradrenaline.”

According to Nakagawa (Nakagawa, M. “Homeostatic and Protective Effects of Taurine” in Taurine: Functional Neurochemistry, Physioloay, and Cardiology, pp 447-449, Wiley-Liss, Inc., 1990), taurine inhibits the sympathetic nervous system. “This inhibitory effect could be centrally derived, since intraventricular administrations of taurine inhibited sympathetic nerve activity.” This effect may be due to an inhibition of the release of norepinephrine (i.e., noradrenaline) by taurine.

Besides taurine, the present invention also contains at least one additional ingredient. The additional ingredient or ingredients can be chosen from a variety of possible nutritional additives that can enhance the nutritional value, functionality, or taste and palatability of a caffeine-containing beverage. For example, a premeasured volume of taurine and a sweetener can be provided in a paper packet. The sweetener can be a natural sugar such as sucrose, or an artificial sweetener such as aspartame. As another example, taurine, a sweetener, and a coffee creamer can be provided in a premeasured volume, either as a granulated solid mixture in a paper packet or as a liquid in a small container, for mixing with a caffeine-containing beverage. Additional ingredients that are nutritional additives can include vitamins, minerals, sugars, polysaccharides, amino acids, proteins, polypeptides, nucleic acids, herbs and herbal extracts, micronutrients and other nutritional substances. Flavoring agents can be used as additional ingredients to enhance the palatability of the caffeine-containing beverage. None of the above examples is intended to be limiting in any way.

Nutritional additives can include amino acids, which can be used as additional ingredients in a nutritional supplement that boosts functionality of the caffeine-containing beverage. Tryptophan, for example, has sometimes been described as a natural relaxant that aids in sleep and reduces anxiety. In rats, “repeated moderate tryptophan depletion leads to anxiogenic and depressive-like behaviour” (Blokland et al., Psychopharmacol. 2002 March;16(1):39-49). Thus, tryptophan can be useful to counteract the potential anxiety producing effects of excess caffeine.

Phenylalanine, which is used by the brain to produce norepinephrine, is another example of an amino acid that can be used to boost the functionality of a caffeine-containing drink. According to U.S. Pat. No. 6,261,589, phenylalanine “can be converted by the brain into neurotransmitters noradrenaline and dopamine with the help of the essential nutrient enzyme cofactors folic acid, vitamin C, copper, and vitamin B-6 and into the neuromodulator beta phenylethylamine with the help of the essential nutrient enzyme co-factors copper and vitamin B-6.” Therefore, when phenylalanine is used as an additional ingredient in the present invention, it is advantageous also to provide folic acid, vitamin C, copper, and vitamin B-6 in the formulation. With these enzyme cofactors, the brain converts phenylalanine into the neuromodulator beta phenylethylamine, which may improve the experience of emotions, and may even lead to a feeling of wellbeing. Providing the nutrients that are used in the production of noradrenaline and other neurotransmitters diminishes the possibility of depletion of these neurotransmitters due to excessive caffeine intake.

The amino acid, tyrosine, is another example of an additional ingredient that can be used in the present invention. In a placebo controlled study, within an hour of ingesting 100 mg/kg of tyrosine, subjects put under stress improved their cognitive performance (Deijen, et al. Effect of tyrosine on cognitive function and blood pressure under stress. Brain Res Bull. 1994;33(3):319-23). Deijen, et al., in another study, concluded “that supplementation with tyrosine may, under operational circumstances characterized by psychosocial and physical stress, reduce the effects of stress and fatigue on cognitive task performance.” (Deijen, et al. Tyrosine improves cognitive performance and reduces blood pressure in cadets after one week of a combat training course. Brain Res. Bull. 1999 Jan. 15;48(2):203-9) Neri, et al. also studied the effect of tyrosine on cognitive performance. From their controlled study using a dose of 150 mg/kg, they concluded that: “Tyrosine administration was associated with a significant amelioration of the usual performance decline on a psychomotor task and a significant reduction in lapse probability on a high-event-rate vigilance task.” (Neri et al. The effects of tyrosine on cognitive performance during extended wakefulness. Aviat. Space Environ. Med. 1995 April;66(4):313-9.)

Amino acids beyond those already discussed can also be used as additional ingredients. For example, an amino acid additive may include any one of, or mixtures of, the following: alanine, arginine, asparagine, aspartic acid, cysteine, glutamine, glutamic acid, glycine, histidine, isoleucine, leucine, lysine, methionine, proline, pyroglutamate, serine, threonine, valine, and other amino acids known in the art.

Examples of sweeteners as nutritional additives that can be used in the present invention include: sucrose, glucose, fructose, honey, saccharin, aspartame, cyclamate, stevioside, acesulfame k, sucralose, alitame, neohesperidine dc, thaumatin, sucaryl, xylitol, and the like. One or more of these and other sweeteners known in the art can be used in addition to the taurine of the present invention. This list of sweeteners is exemplary only, and is not meant to be limiting in any way.

Carbohydrate sweeteners such as sucrose, glucose, fructose, honey and the like, when used as an additional ingredient or additional ingredients in the present invention, provide an added energy boost to the caffeine-containing beverage that is converted into an energy drink. Glucose has been shown to improve memory in humans (Messier, C. Glucose improvement of memory: a review. Eur. J. Pharmacol. 2004 Apr. 19;490(1-3):33-57). Glucose in combination with caffeine “can ameliorate deficits in cognitive performance and subjective fatigue during extended periods of cognitive demand.” (Kennedy D. O., et al. A glucose-caffeine ‘energy drink’ ameliorates subjective and performance deficits during prolonged cognitive demand. Appetite. 2004 June;42(3):331-3). Glucose and other natural sugars can be provided as ingredients directly, or as polysaccharides that are then digested after ingestion.

Non-caloric sweeteners can be used as an additional ingredient or ingredients when it is desired to minimize the caloric content of the nutritional supplement of the present invention. Although no energy benefit is specifically derived from these sweeteners, they are useful in making the caffeine beverage more palatable. Aspartame, however, is a source of phenylalanine, which may be of energy benefit because it is a precursor in the production of noradrenaline and other neurotransmitters as has already been discussed.

Nutritional additives such as vitamins, vitamin components, and essential nutrients can be used for their known nutritional value as additional ingredients. Thus a vitaminic additive can include any one of, or mixtures of: Vitamin A, Vitamin C, Vitamin D, Vitamin E, Vitamin K, Thiamin, Riboflavin, Niacin, Vitamin B₆, Folic Acid, Vitamin B₁₂, Biotin, Pantothenic Acid, and other vitamins and vitamin components known in the art.

Maintaining adequate levels of vitamins and minerals is essential to health. Many disorders due to vitamin and mineral deficiencies are well known in the art. For example, cognitive decline is a well known problem in the elderly in which diet plays a possible role. “Vitamin deficiencies, especially vitamin B6, B12 and folates, and antioxidant deficiencies (vitamins E and C) could also influence the memory capabilities and have an effect on cognitive decline.” (Solfrizzi V., et al. The role of diet in cognitive decline. J. Neural Transm. 2003 January;110(1):95-110)

Minerals and mineral components can be used for their nutritional value as additional ingredients. Thus, a mineral additive can include any one of, or mixtures of, the following minerals or nutritionally acceptable compounds thereof: Calcium, Copper, Iron, Phosphorus, Iodine, Magnesium, Zinc, Selenium, Copper, Manganese, Chromium, Molybdenum, Chloride, Potassium, Boron, Nickel, Silicon Tin, Vanadium, and other nutritionally important minerals known in the art.

Minerals are well known to play important roles in the maintenance of health and well-being. Selenium, for example, is a component of glutathione peroxidase, an important natural antioxidant enzyme. It is an important component of the p-450 enzyme systems and it also plays a role in cancer cell apoptosis. As another example of the importance of minerals, insufficient intake of zinc, copper, chromium, and magnesium may affect one's likelihood of developing arteriosclerosis. The role copper plays in the synthesis of noradrenaline and other neurotransmitters has already been discussed. Many of the physiologic mechanisms in which minerals play a part are now well known in the art.

Proteins can be used as nutritionally beneficial, additional ingredients. For example, a protein additive may include any one of, or mixtures of the following: Whey Protein, Casein, Soy Protein, Albumin, muscle protein, cereal protein, seaweed protein, and other proteins known in the art. When digested, proteins are broken down into their constituent amino acids. Thus, proteins are a source of amino acids, some benefits of which have already been discussed.

Whey protein and casein are derived from milk and can be used in the present invention as components in a creamer mixture, which, in addition to taurine and, perhaps, other ingredients, can be used to make coffee, tea, cocoa, or other caffeine-containing beverage more palatable. If desired, the other listed proteins can be used as formulation components or as nutritional supplements as is well known in the art.

Various forms of milk can be used as a nutritional additive ingredient in the present invention in addition to taurine. For example, powdered whole milk or skim milk can be part of a dry formulation provided in paper packets that can be used as a coffee or tea whitener. As another example, cream, half-and-half, whole milk, or skim milk, derived from cow's milk, or any soy milk product, can be provided, with other ingredients of the present invention, in a container as a liquid formulation for whitening coffee or tea and the like.

Non-dairy creamers can be used in the present invention instead of milk products. Non-dairy creamers are typically complex oil-in-water emulsions that also can include fats, carbohydrates, and proteins (including casienates used as emulsifiers). Most powdered creamers start out as liquid emulsions that are subsequently spray dried. Either a liquid or powdered non-dairy creamer can be used as an ingredient in addition to taurine in the present invention.

A variety of nutritional additives such as bioactive nutrients and substances can also be used as additional ingredients. For example, the following bioactive nutrients can be chosen as part of the supplement of the present invention: inositol, creatine, carnitine, acetyl carnitine, lipoic acid, gamma-aminobutyric acid, carnosine, choline, cytidine diphosphocholine, dimethyl-amino-ethanol, S-adenosyl-L-methionine, quercetin (flavonoid), lycopene, glycosaminoglycan, phosphatidylserine, and other bioactive nutrients known in the art. These can be used as an additional ingredient to taurine and may be added to the nutritional supplement of the present invention as a bioactive nutritient additive made up of one of, or a mixture of, the above bioactive nutrients.

Other proteins and compounds may be used as components of the taurine-containing additive. Carnitine and acetyl-L-carnitine both play a role in the functioning of mitochondria, the powerhouses of cells. Some animal experiments suggest that supplementation with carnitine or acetyl carnitine may improve cognitive ability and diminish fatigue. Choline is a vitamin-like substance that is now believed by many investigators to be an essential nutrient. As a precursor of the neurotransmitter acetylcholine, it may be beneficial in controlling mood, improving memory, and stimulating alertness and mental energy. Cytidine diphosphocholine, a choline related compound, has been shown to raise plasma choline levels in animals, and as such, is thought to be another way of increasing acetylcholine levels in the brain. Creatine is well known as a supplement used by body builders to increase short-term muscle strength and to produce quick bursts of energy. Dimethylaminoethanol (DMAE) may be a precursor of acetylcholine but its mechanism of action is possibly still unknown. It has been reported to enhance learning and memory and, as a supplement, is marketed as a “brain booster.” Gamma-aminobutyric acid (GABA) is a neurotransmitter that some believe, when it is taken as a supplement, augments the brain's natural supply of GABA. Some studies suggest that inositol helps regulate serotonin, and thus has a mood altering effect. Lipoic acid, a vitamin-like substance with antioxidant properties, has been shown in some animal experiments to improve memory and cognitive function. Although results have not been consistent, some studies show that lycopene in the blood may have a protective effect on the nervous system. This may be related to lycopene's potential role in preventing oxidative damage to the central nervous system. Lycopene has also been shown to have anti-cancer activity. The bioflavonoid, quercetin, is a strong antioxidant that has been shown in an animal model to reverse age-related or chronic ethanol-induced memory deficits. Investigations of S-adenosyl-L-methionine (SAMe) for use against a variety of neurological disorders, Alzheimers disease, dementia and depression have yielded promising results. Coenzyme Q10 plays an important role in the production of energy in cells, that is, in the processing of nutrients into ATP. Because ATP cannot be stored, an adequate, continuing supply of Coenzyme Q10 is critical. Glycosaminoglycans have been reported to be an effective agent in treating old age dementias, and in an animal model, it has been shown to improve learning when injected intraventricularly. Similarly, phosphatidylserine was shown to be effective against cognitive decline in the elderly and also had beneficial effects on brain functions in animal models.

In the present invention, nutritional additives such as herbs and extracts can be used as additional ingredients along with taurine in the present invention. Various processed (e.g., extracts) or unprocessed forms of the following herbs are contemplated as choices for additional nutritional ingredients in the present invention: Ginseng, tea (e.g., white tea, green tea, black tea), guarana, gingko, echinacea, cinnamon, chamomile, kola nut, yerba maté, kava kava, yohimbe, elderberry, grape seed, turmeric (curcumin), milk thistle (e.g., silymarin), schisandra, panax quinquefolium, reishi, damiana, chocolate, carob, and other herbs known in the art. These herbs have been used in a variety of formulas for functional energy drinks and health drinks, but not, as in the present invention, in a nutritional supplement that is added to a caffeine-containing beverage so as to render it an energy drink.

Chamomile is a well-known folk remedy for insomnia and anxiety. It contains apigenin, which accounts for its anti-anxiety and sedative effects, and works in an analogous way to diazepam. Chocolate has long been known for its ability to improve mood and cognitive function. Cinnamon is known as a digestion aid that can relieve upset stomach, gas, and diarrhea. It has potential use in ameliorating digestive problems that could occur from an excess of caffeine intake from a caffeine-containing beverage. Elderberry has been shown to be active against influenza, and has long been considered a useful treatment with antiviral activity against colds, herpes, and other virus-related illnesses. Gingko biloba and its extracts have long been studied and used for the prevention and treatment of neurodegenerative pathologies. It also appears to improve mood and cognitive function in some individuals. Ginseng, in its various varieties (e.g., Asian, American, Siberian), is well known as a general health tonic that can increase physical stamina and mental alertness, counter stress, and relieve nervousness and restlessness. Instead of coffee, gotu kola has been used by some people in the morning because they believe it improves memory and clarity of thinking. Grape seed extracts have been shown to have cardioprotective actions. Furthermore, animal experiments suggest that grape seed extracts can protect against ischemic neuronal damage and, thus, may have neuroprotective properties. Guarana is a common ingredient in many energy drinks and may also be used in the present invention, as can kola nuts and yerba maté. Reishi is a mushroom that has been reported to ease tension, improve memory, and sharpen concentration and focus. In an animal model, chemical constituents of schisandra have been shown to enhance cognitive function.

Tea and tea extracts contain many phytochemicals (e.g., catechins, polyphenols) known to have beneficial health effects. These include anti-oxidant and, possibly, anti-cancer actions. In an animal model, tea polyphenols were shown to reverse scopolamine induced retention deficits. Tea also had an inhibitory effect on acetylcholinesterase activity. Caffeine may occur in varying amounts as a natural constituent of some of the above-discussed herbs and, therefore, be incorporated into the present invention by virtue of using a specific herb. However, caffeine, in and of itself, is not considered an ingredient of the present invention.

In the preferred embodiment, the present invention comprises 500 to 1000 mg of taurine in a granular powder form. It also contains at least one other active ingredient, which is, preferably, about one teaspoon of sucrose or less, also in a granular form. Inactive ingredients, known in the art, may be added, for example, to enhance flow characteristics, aid in dispersal, and/or prevent caking. Preferably, the granular formulation is packaged in a paper packet containing a single serving. To use this embodiment, the prospective drinker rips open the paper packet, pours the granular contents into a caffeine-containing beverage, such as coffee, and stirs to facilitate dispersal of the supplement into the beverage. When the supplement is mixed with the caffeine-containing beverage, an energy drink results.

In an alternative embodiment, the present invention comprises 500 to 1000 mg of taurine in a granular powder form and about 1 gm of the sweetener, aspartame (powdered), which is the sweetness equivalent of about two teaspoons of sugar. As with the preferred embodiment, this alternative embodiment may contain inactive ingredients known in the art. Preferably, the granular formulation is packaged in a paper packet containing a single serving. This embodiment is used in a way similar to that of the preferred embodiment already described.

In yet another alternative embodiment, the present invention comprises 500 to 1000 mg of taurine dissolved or dispersed in approximately 10-15 ml of a dairy or non-dairy creamer. The formulation preferably also includes sweeteners such as sucrose or aspartame. The liquid supplement is contained preferably in single-serving containers similar to those currently known in the art of creamers. To use this embodiment, the prospective drinker removes the top paper and foil cover of the single serving container and pours the contents into a caffeine-containing beverage such as coffee or tea. Stirring can facilitate mixing of the supplement with the beverage. When the liquid contents of the container are mixed with the caffeine-containing beverage, an energy drink results.

In still another alternative embodiment, the present invention comprises 500 to 1500 mg of taurine in granular form, about 500 to 750 mg of glucuronolactone, about 20 mg of niacin, about 5 mg of vitamin B6, about 2.5 to 10 mg of pantothenic acid, about 0.005 mg of vitamin B12, about 15 to 25 gm of sucrose, and about 2.5 to 7.5 gm of glucose. In a diet form of this embodiment, the sucrose and glucose are replaced by aspartame and/or acesulfame K. Inactive ingredients may also be included in this formulation. Preferably this granular product formulation is contained in a single serving paper packet. To use this embodiment, the prospective drinker rips open the paper packet, pours the granular contents into a caffeine-containing beverage, such as coffee, tea, or a cola and stirs to facilitate dissolving the supplement into the beverage. When the supplement is mixed with the caffeine-containing beverage, an energy drink results.

As mentioned, inactive ingredients, well known in the art, may be used in various embodiments of the present invention. These include organic or inorganic additives such as conventional fillers, extenders, and excipients. For example, the product may include, but not be limited to, fillers such as lactose, mannitol or sorbitol, cellulose preparations and/or calcium phosphates, such as tricalcium phosphate or calcium hydrogen phosphate, binders such as starches (e.g., maize starch, wheat starch, rice starch, potato starch), gelatin, tragacanth, methyl cellulose, hydroxypropylmethylcellulose, sodium carboxymethylcellulose, and/or polyvinyl pyrrolidone. Flow regulating agents and/or lubricants such as silica, talc, calcium stearate, magnesium stearate and/or polyethylene glycol may be added. Stabilizers known in the art also may be used. Disintegrating agents may be added such as the above-mentioned starches and also carboxymethyl-starch, cross-linked polyvinyl pyrrolidone, agar, or alginic acid or a salt thereof, such as sodium alginate.

In addition to the above-described embodiments, the present invention can be formulated in other ways well known in the art. For example, as a dry solid form, it can be provided as a cube and used much like sugar cubes that are added to coffee and tea. It can also be provided as a quickly disintegrating tablet that is stable when dry, but easily mixed when stirred into a caffeine-containing drink. The present invention can also be provided as effervescent tablets, beads, powders of different mesh, and dispersible granules. These formulations are described for exemplary purposes only and are not meant to be limiting in any way.

In the present invention, taurine and an additional substance or additional substances may be ground and mixed together by conventional mixing equipment. The resulting powdered mixture may then be packaged in paper packets or pressed into cubes, tablets, or other form, and then packaged appropriately.

In liquid embodiments, taurine and any other dry ingredients can be dissolved or suspended in liquid components of the product. For example, if the embodiment is a liquid dairy or non-dairy creamer, the solid components of the product may first be dissolved in a minimal amount of water, and then, as a liquid solution, mixed with the creamer. Alternatively, the dry ingredients can be dissolved or suspended directly in the liquid dairy or non-dairy creamer.

The preferred embodiment and various modifications of the concept underlying the present invention have been set forth. Various other embodiments of the present invention, and modifications of the embodiments herein shown and described will occur to those skilled in the art upon becoming familiar with the disclosure herein. It is to be understood, therefore, that the invention may be practiced otherwise than as specifically set forth herein.

I claim:

1. A nutritional supplement for mixing with a caffeine-containing beverage, comprising:
(a) taurine; and
(b) at least one ingredient selected from the group consisting of a sweetener, a vitaminic additive, a mineral additive, an amino acid additive, an herbal additive, bioactive nutrient additive, a creamer, proteins, glucuronolactone, a flavoring, and mixtures thereof, whereby, said nutritional supplement, when mixed with said caffeine-containing beverage, yields a functional energy drink.

2. The composition of claim 1 wherein said sweetener is comprised of at least one of sucrose, glucose, fructose, honey, saccharin, aspartame, cyclamate, stevioside, acesulfame k, sucralose, alitame, neohesperidine dc, thaumatin, sucaryl, xylitol, and mixtures thereof.

3. The composition of claim 1 wherein said vitaminic additive is comprised of at least one of Vitamin A, Vitamin C, Vitamin D, Vitamin E, Vitamin K, Thiamin, Riboflavin, Niacin, Vitamin B6, Folic Acid, Vitamin B12, Biotin, Pantothenic Acid, and mixtures thereof.

4. The composition of claim 1 wherein said mineral additive is comprised of at least one of Calcium, Copper, Iron, Phosphorus, Iodine, Magnesium, Zinc, Selenium, Copper, Manganese, Chromium, Molybdenum, Chloride, Potassium, Boron, Nickel, Silicon Tin, Vanadium.

5. The composition of claim 1 wherein said amino acid additive is comprised of at least one of alanine, arginine, asparagine, aspartic acid, cysteine, glutamine, glutamic acid, glycine, histidine, isoleucine, leucine, lysine, methionine, phenylalanine, proline, pyroglutamate, serine, threonine, tryptophan, tyrosine, and valine.

6. The composition of claim 1 wherein said herbal additive is at least one of ginseng, tea, guarana, gingko, Echinacea, cinnamon, chamomile, kola nut, yerba maté, kava kava, yohimbe, elderberry, grape seed, turmeric, milk thistle, schisandra, reishi, damiana, chocolate, carob, and extracts thereof.

7. The composition of claim 1 wherein said bioactive nutrient additive is at least one of inositol, creatine, carnitine, acetyl carnitine, lipoic acid, gamma-aminobutyric acid, carnosine, choline, cytidine diphosphocholine, dimethyl-amino-ethanol, S-adenosyl-L-methionine, quercetin, lycopene, glycosaminoglycan, and phosphatidylserine.

8. A nutritional supplement for mixing with a caffeine-containing beverage, comprising:
(a) first ingredient means for counteracting the negative side-effects of caffeine, and
(b) at least one additional second ingredient selected from the list consisting of a nutritional additive and a sweetener,
whereby said nutritional supplement, when mixed with said caffeine-containing beverage, yields a functional energy drink.

9. The composition of claim 8 wherein said first ingredient means for counteracting the negative side-effects of caffeine is taurine.

10. The composition of claim 8 wherein said sweetener comprises at least one of sucrose, glucose, fructose, honey, saccharin, aspartame, cyclamate, stevioside, acesulfame k, sucralose, alitame, neohesperidine dc, thaumatin, sucaryl, xylitol, and mixtures thereof.

11. The composition of claim 8 wherein said nutritional additive comprises at least one of Vitamin A, Vitamin C, Vitamin D, Vitamin E, Vitamin K, Thiamin, Riboflavin, Niacin, Vitamin B6, Folic Acid, Vitamin B12, Biotin, Pantothenic Acid, Calcium, Copper, Iron, Phosphorus, Iodine, Magnesium, Zinc, Selenium, Copper, Manganese, Chromium, Molybdenum, Chloride, Potassium, Boron, Nickel, Silicon Tin, Vanadium, alanine, arginine, asparagine, aspartic acid, cysteine, glutamine, glutamic acid, glycine, histidine, isoleucine, leucine, lysine, methionine, phenylalanine, proline, pyroglutamate, serine, threonine, tryptophan, tyrosine, and valine, ginseng, tea, guarana, gingko, Echinacea, cinnamon, chamomile, kola nut, yerba maté, kava kava, yohimbe, elderberry, grape seed, turmeric, milk thistle, schisandra, reishi, damiana, chocolate, carob, inositol, creatine, carnitine, acetyl carnitine, lipoic acid, gamma-aminobutyric acid, carnosine, choline, cytidine diphosphocholine, dimethyl-amino-ethanol, S-adenosyl-L-methionine, quercetin, lycopene, glycosaminoglycan, and phosphatidylserine

12. A method for converting a caffeine-containing beverage into a functional energy drink, comprising the steps of:
(a) providing a first ingredient for counteracting uncomfortable side-effects of caffeine, and
(b) providing at least one additional nutritional additive second ingredient, and
(c) mixing said first and said second ingredients with a caffeine-containing beverage to yield a functional energy drink.

13. The method of claim 12 wherein said first ingredient for counteracting uncomfortable side effects of caffeine is taurine.

14. The method of claim 12 wherein said additional ingredient is one of a sweetener, a vitaminic additive, a mineral additive, an amino acid additive, an herbal additive, bioactive nutrient additive, a creamer, proteins, glucuronolactone, a flavoring, and mixtures thereof.

15. The method of claim 14 wherein said sweetener is comprised of at least one of sucrose, glucose, fructose, honey, saccharin, aspartame, cyclamate, stevioside, acesulfame k, sucralose, alitame, neohesperidine dc, thaumatin, sucaryl, xylitol, and mixtures thereof.

16. The method of claim 14 wherein said vitaminic additive is comprised of at least one of Vitamin A, Vitamin C, Vitamin D, Vitamin E, Vitamin K, Thiamin, Riboflavin, Niacin, Vitamin B6, Folic Acid, Vitamin B12, Biotin, Pantothenic Acid, and mixtures thereof.

17. The method of claim 14 wherein said mineral additive is comprised of at least one of Calcium, Copper, Iron, Phosphorus, Iodine, Magnesium, Zinc, Selenium, Copper, Manganese, Chromium, Molybdenum, Chloride, Potassium, Boron, Nickel, Silicon Tin, Vanadium.

18. The method of claim 14 wherein said amino acid additive is comprised of at least one of alanine, arginine, asparagine, aspartic acid, cysteine, glutamine, glutamic acid, glycine, histidine, isoleucine, leucine, lysine, methionine, phenylalanine, proline, pyroglutamate, serine, threonine, tryptophan, tyrosine, and valine.

19. The method of claim 14 wherein said herbal additive is at least one of ginseng, tea, guarana, gingko, Echinacea, cinnamon, chamomile, kola nut, yerba maté, kava kava, yohimbe, elderberry, grape seed, turmeric, milk thistle, schisandra, reishi, damiana, chocolate, carob, and extracts thereof.

20. The method of claim 14 wherein said bioactive nutrient additive is at least one of inositol, creatine, carnitine, acetyl carnitine, lipoic acid, gamma-aminobutyric acid, carnosine, choline, cytidine diphosphocholine, dimethyl-amino-ethanol, S-adenosyl-L-methionine, quercetin, lycopene, glycosaminoglycan, and phosphatidylserine.
